(19) United States
(12) Patent Application Publication
(10) Pub. No.: US 2011/0169933 A1
(43) Pub. Date: Jul. 14, 2011

(54) METHOD AND SYSTEM FOR CENTRALIZING CONSTRUCTION OF IMAGES

(75) Inventor: Pierre-Jean Touboul, Paris (FR)

(73) Assignee: INTELLIGENCE IN MEDICAL TECHNOLOGIES, Paris (FR)

(21) Appl. No.: 13/055,471

(22) PCT Filed: Jul. 28, 2009
(86) PCT No.: PCT/FR2009/000937

§ 371 Date: Mar. 28, 2011

(30) Foreign Application Priority Data
Jul. 31, 2008 (FR) 08/04376

(51) Int. Cl. H04N 7/18; H04N 5/225

(52) U.S. Cl. 348/77; 348/207.1; 348/E07.085; 348/E05.048

(57) ABSTRACT

A method for centralising the construction of images including a step of acquiring at least one radiofrequency signal with a sensor of at least one local imaging device, a step of transmitting the radiofrequency signal emanating from the sensor to the centralised processing unit, a step of processing the radiofrequency signal with a view to constructing an image, and a step of transmitting the image constructed to a display of the acquisition device. The transmission between the sensor and the processing unit and the transmission between the processing unit and the display are performed via a telecommunications network Prior to the step of transmitting to the processing unit, the radiofrequency signal emanating from the sensor is converted into a format compatible with the telecommunications network. A system for the centralised construction of images implementing such a method is described.

### BACKGROUND

### Field of the Invention

The invention relates to a method for centralizing the construction of images and a system implementing such method, including at least one device able to transmit a radiofrequency signal from control means, and a centralized processing unit making it possible to construct successive images from the received signals.

The present invention relates to the field of imaging, more particularly medical imaging and in particular echography, implementing sensors, for example echography probes, the signals of which are transformed for viewing purposes by a processing unit.

### PRIOR ART

The state of the art in the field of echography imaging includes complete echography systems located at the same place. Such echography systems thus include an echography probe generating a radiofrequency signal, means for controlling the probe as well as processing means making it possible to convert the radiofrequency signals into an echography image. They can also include means performing additional processing functions able to facilitate the interpretation of the echography images.

The drawbacks involved in the echography systems lie, on the one hand, in their overall dimensions which prevent their being moved and, on the other hand, in their purchasing and maintenance costs. These represent 10 to 20% of the initial cost on a yearly basis. Their updating is constantly carried out through lack of information, organisation or the extra cost they entail.

Another present limit to the utilisation of such echography systems is the lack of harmonisation as regards data acquisition modes and criteria, as well as the interpretation thereof. This lack of harmonisation requires dedicated services:
to the monitoring of the examination for a specific training or the opinion of an expert, more particularly for medical emergencies,
to the transmission of images for an offline specific evaluation,
for the utilisation of applications making it possible to improve the quantisation, archiving and saving echography images,
to the construction of an expert system based on the automatic analysis of the image base with a view to obtaining an automated diagnostic orientation.

The patent document US 2005/0049495 describes a connection between echography devices. In this document, a server is connected by echography through a computer network of the Internet type to several medical diagnosis devices. The server includes one or several processors or any other type of data processing and communication means on a network. The server receives and processes echography imaging information emanating from the various locations and transmits the results of the processing to the imaging device which transmitted the imaging information. The medical diagnosis devices include displays for echography images obtained from the probes. Such a remote medical diagnostic assistance system thus enables several users located at various locations to have access to information from a central location via Internet.

However, such a solution does not make it possible to locally omit the processing unit since it locally provides a sensor and echography signal processing means. As a matter of fact, the signals emanating from the echography probe are converted by an imaging device into an echography image for viewing purposes. Such image data are then sent to the remote server which processes the images with a view to supplying more precise information required for the diagnosis. Thus, this solution locally includes means for converting the radiofrequency signal into an echography image, which blocks, and increases the cost of each local echography imaging device.

Another solution is described in the patent document U.S. Pat. No. 5,851,186. In this document, an ultrasonic imaging diagnosis system includes several ultrasonic imaging devices, a hub, a local network server, a computer device and an interface with the Internet network. Each ultrasonic imaging device is connected via a serial line to the hub, which provides the interconnection between the various serial lines. The local network server is composed of a computer having network communications elements as well as means for storing ultrasonic images and for transmitting said ultrasonic images on the network. The computer device can access the local network server and to the ultrasonic imaging devices of the network. Such a system thus provides access to ultrasonic imaging devices via a network, through existing software and hardware.

However, the drawback of such a solution lies in the overall dimensions and the cost of each ultrasonic imaging device. The echography images are directly formed at the local ultrasonic imaging device and these images only are transmitted to the central network server with a view to being processed to obtain diagnosis information. This requires appropriate conversion means to construct the echography image from the signal emanating from the probe.

Then, no state of the art solution makes it possible to minimise the overall dimensions and the cost of an ultrasonic imaging echography system. As a matter of fact, each echography device is locally provided with means for constructing an echography image.

### SUMMARY OF THE INVENTION

The object of the present invention is to remedy this technical problem by making it possible to reduce a minima the content of each local device. Therefore, it provides the centralisation of all the elaborate means for constructing an image by transmitting, through a network, the data emanating from the sensor of each local device to a centralised and moved processing unit.

For this purpose, it is provided to fit each local imaging device and the centralised processing unit with an interface with a telecommunications network and to locally provide means for the specific processing of raw data emanating from the sensor into a format and a volume complying with a quick transfer on the network. Each local device is then reduced to one sensor and minimum computer equipment including a display, a network interface, and digital raw data processing dedicated means to make them compatible with said network.

More precisely, the aim of the invention is a method for centralising the construction of images including a step of acquiring at least one radiofrequency signal via a sensor of at least one local imaging device, a step of transmitting the radiofrequency signal emanating from the sensor, a step of processing said radiofrequency signal with a view to constructing an image and a step of transmitting the constructed image to the display of said acquiring device. This method is remarkable in the fact that the transmission between the sensor and said processing unit, and the transmission between said processing unit and the display are carried out by a telecommunications network, and that, prior to said step of transmission to said processing unit, the radiofrequency signal emanating from said sensor is converted and compressed into a format compatible with the telecommunications network.

This method makes it possible to minimise the overall dimensions and the cost of a local echography device. As a matter of fact, each local echography device only includes the display, the sensor, as well as means for controlling the probe and means for converting the radiofrequency signal into a format compatible with the transfer on a telecommunications network. All the calculations involving an important load are moved to the centralised processing unit. The image can then be constructed at the server and transmitted to the local echography device, which makes it possible to omit local high capacity calculation means.

According to one embodiment aiming at having a data transmission rate authorizing real time processing, it is provided that, during the step of transmission between the sensor and said processing unit, one radiofrequency signal out of two is transmitted to said unit and that during the step of processing said radiofrequency signal, the missing signals are reconstructed by interpolation of at least two successive transmitted signals. The missing images can then be reconstructed, which makes it possible to carry out a real time processing while having a lower transmission rate.

The invention also relates to a system for centralising the construction of images including at least one imaging device capable of acquiring a radiofrequency signal and of displaying an image, with each imaging device including a sensor, a display and means for controlling the sensor, said system also including a centralised processing unit capable of constructing an image from the radiofrequency signal emanated from said sensor, said unit including means for converting said radiofrequency signal into an image. This system is remarkable in that each imaging device and each unit include an interface with means for converting said radiofrequency signal into a format compatible with the transfer on said telecommunications network.

According to a first embodiment, it is provided that the telecommunications network is a network of the Internet type.

According to a second embodiment, it is provided that the telecommunications network is a network of the microwave type.

According to one embodiment aiming at reducing the overall dimensions and the cost of the ultrasonic imaging echography devices for the echography imaging, it is provided that the sensor will be an echography probe. In this case, the local echography device then only includes one probe, one standard computer provided with display means and a network interface.

According to one embodiment aiming at improving the security of the device, it is provided that the device includes a security processing unit moved to a more secure location than the location of the centralised processing unit, with said unit including means for converting the radiofrequency signal into an image and an interface with said telecommunications network.

According to one embodiment aiming at increasing the number of information that the device can supply, it is provided that the centralised processing is associated with means for processing the echography images with a view to improving the interpretation of such images.

According to one embodiment aiming at diversifying a connection means between the probe and the local computer, it is provided that such connection will be a wire or a m connection, microwave, more particularly through the “wi-fi” or “Bluetooth” radiofrequency technologies.

### BRIEF DESCRIPTION OF THE DRAWINGS

The invention will be better understood upon reading the detailed description of a non limitative exemplary embodiment, and referring to the appended drawings, showing respectively:

FIG. 1, the diagram of a system for the centralised construction of echography images according to a first embodiment,

FIG. 1a, a functional diagram of a system for the centralised construction of images according to the invention,

FIG. 2, a diagram of a system for the centralised construction of echography images according to a second embodiment, and

FIG. 3, a diagram of an exemplary embodiment of a system for the centralised construction of echography images.

### DETAILED DESCRIPTION OF THE PREFERRED EMBODIMENTS

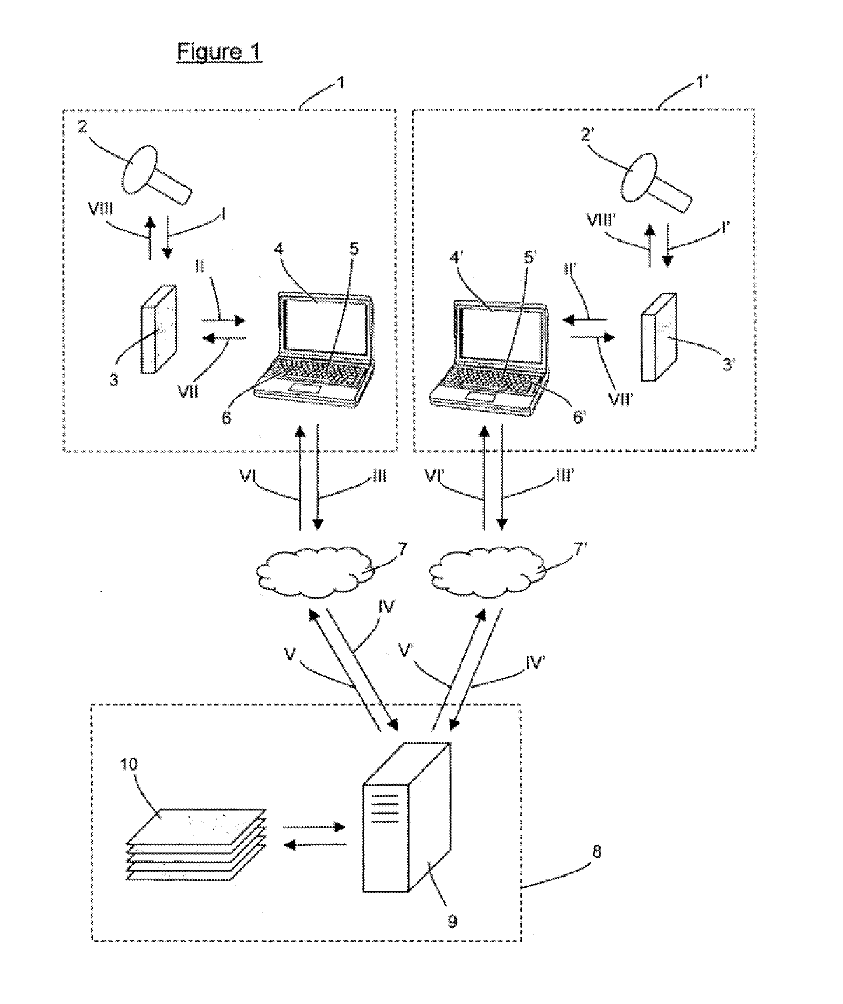

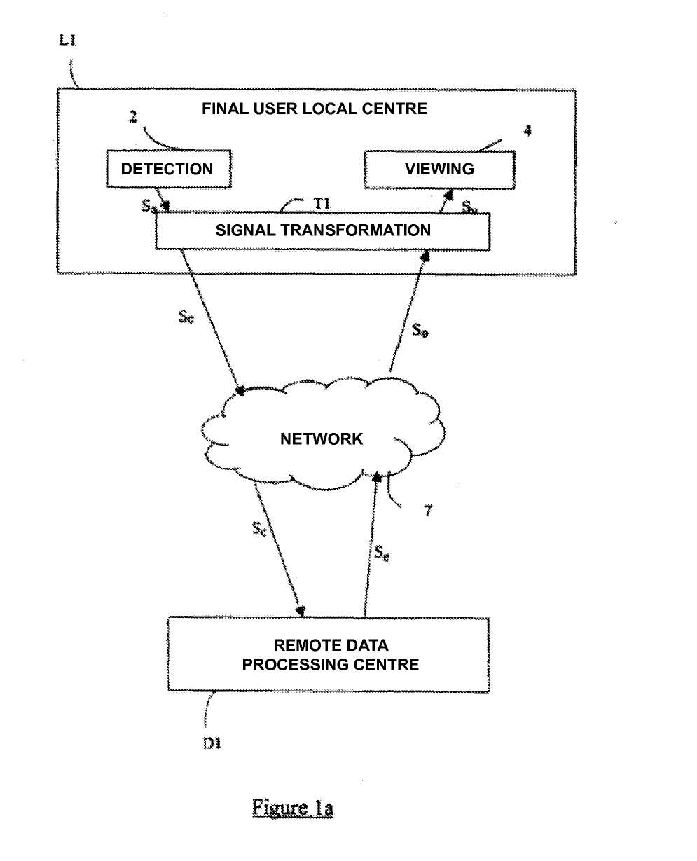

The diagram illustrated in FIG. 1 relates to a diagram of a centralised system for the construction of images according to the invention, which relates, in the illustrated example, echography imaging and including, to be simple, two echography probes and a centralised processing system. It should be noted that the system can also include any number of echography probes, more particularly more than two, and several centralised processing systems.

The system includes local echography imaging devices 1 and 1′ and one remote centralised processing unit 8. Each echography device is capable of generating and emitting a radiofrequency signal, or RF signal. Each device therefor includes an echography probe 2, 2′, digitizing means 3, 3′, as well as means for viewing 4, 4′ echography images, materialised by viewing screens in the example, means for controlling 5, 5′ the probe, materialised by keyboards, and processing means 6, 6′. Such control, viewing and processing systems are included in a computer 20, 20″ connected to the echography probe 2, 2′ via the digitizing means 3, 3′ (arrows I, II; I′, II′). Each device also has a connection interface (arrow III, III′) with a telecommunications network 7.

Each probe 2, 2′ is a line-scanning ultrasonic probe operated in a frequency band between 2 and 20 MHz. Alternatively, the scanning can be a sector scanning or any other scanning type.

More precisely, the frequency band depends on the application desired, i.e. 2 to 3.5 MHz for deep organs, 3.5 to 7 MHz for the heart, the kidneys or liver, and 7 to 20 MHz for superficial organs. Each probe is provided with electric power means, composed of a supply box via a wire connection or rechargeable batteries, or else a supply through a USB bus. The transmission/reception area of each probe can be composed for example of 1(for a sector scanning) or 128 piezoelectric crystals. The handle 2a, 2′ of the probe includes the stacking of integrated circuits having small dimensions to perform the acquisition of the radiofrequency signals and the digitizing thereof. Each probe 2, 2′ is finally fitted with luminescent diodes (not shown) indicating the on, off, transmission or reception conditions. The signal generated by the echography probe is a signal of analog origin, delivered by several piezoelectric sensors.

Each digitizing means 3, 3′ is composed, in the illustrated embodiment, of a printed circuit which can be integrated in the probe used or, according to an alternative solution, to an external box. Such printed circuit makes it possible to digitise the analog signal emanating from the probe. Digitizing is specific to each probe since the signal sampling frequency depends on that of the probe. The radiofrequency signal emitted by the probe is then transmitted (arrows 1, 1′) and sampled at a given frequency, for example of the order of 40 milliseconds, so as to obtain a real time processing (25 images per second).

The digital signal obtained is then transmitted (arrows II, II′) on a wire or a microwave system to the portable computer 20, 20′ including the viewing 4, 4′, controlling 5, 5′ and conversion 6, à 6′ means. The digital processing means carry out the conversion and the compression of the signal which is then ready to be transmitted in data packets to the centralised processing unit 8 via the telecommunications network 7 (arrows III, IV; III′, IV′).

Viewing screens 4, 4′ make it possible to display the back fed video flux through the network 7 after the processing at the centralised processing unit 8 (arrows V, VI; V′, VI′).

Control keyboards 5, 5′ enable the practitioner to remote control the echography probe 2, 2′, and to make adjustments thereon.

The telecommunications network 7 is a network of the Internet type. According to another embodiment of the invention, this network is of the microwave type.

The centralised processing unit 8 makes it possible to synthesise an echography image from the digital signals sent by the conversion means.6, 6′ of the computer 20, 20′ and emanating from the probe 2, 2′.

In order to transfer the raw radiofrequency signal emanating from the probe to the centralised processing unit 8 via the telecommunications network 7, the means for the electronic conversion 6, 6′ of said radiofrequency signal convert the signals into a format compatible with the transfer on said network 7. In the exemplary embodiment, such conversion means can be used by the practitioner in the computer 20, 20′ or according to an alternative solution integrated in the probe. The conversion of the RF signal into a compatible signal includes a step of compressing the signal and a step of encoding the compressed signal. The signal is then transformed into a format compatible with the quick transfer on the network 7, the Internet network, in fact, for example a standard Internet HTTP protocol.

The connection between the pre-processed signal at the probe and the computer can be carried out on a wire, for example USB2 or “FireWire”.

The conversion means 6, 6′ are composed of software capable, on the one hand, of sending the compressed digital signal to the centralised processing unit 8 via the network 7 and, on the other hand, of restituting a decompressed video signal sent back by the centralised processing unit.

The centralised processing unit 8 includes a server 9 and a central unit 10. According to another embodiment, the centralised processing unit 8 includes a plurality of central units. The central unit 10 is composed of a high capacity computer making it possible to construct the echography images from dedicated electronic cards 10a. The server then makes it possible to re-distribute to the local viewing means 4, 4′ the specific signals after the processing through their interface (arrows V, V′) with the telecommunications network 7.

The processing proper of the received signals is carried out by the so-called UTSE (for Echography Signal Processing Units) electronic cards 10a, the characteristics of which are adapted to the quantity of information to be processed. A different card is preferably assigned to each user at the beginning of the operation, i.e. for each local imaging device.

Each card thus forms the remote echography signal processing unit dedicated to one user. The central unit 10 receives the digitised RF signal as an input, decompresses it and transforms it to obtain the echography image. It then transmits the video signals in a re-compressed format as an output, for example of the DICOM, JPEG or MPEG type, to the conversion means 6, 6′ via the network 7 (arrows V, V′; VI, VI′). The decompressed video signal is then supplied to the viewing means.

The server 9 is capable of managing the echography signal databases as well as the applications, if any. Such applications can more particularly be quantisation, printing software or training assistance tools and exams monitoring. The server 9 is additionally capable of storing a part of the incoming flux during peaks of utilisation as well as of distributing the processing of signals between the various central units.

In addition, the probe received the control electric signals emanating from the computer 6, 6′. This is a standard computer, for example a portable microcomputer provided with dedicated software, more particularly:
control electric signals managing software intended for the echography probe further making it possible to adjust the general gains as well as the scanning depth,
software for the transmission via Internet of the signals output by the probe (of the sampled RF type) (HTTP protocol);
a video images reception system,
video images interpolation software to restitute a video flux equivalent to real time.

Software is dedicated to the management of interactions between the probe 2, 2′ and the computer. To be correctly installed, such software successively requires the checking of the computer characteristics to provide compatibility, the request for a serial number of the probe and the installation of drivers, the checking of the connection and of the reception of the RS signal and the lighting of diodes, as well as the checking of gain adjustments, depth adjustments and the supply condition of the probe.

Software is dedicated to the management of the interactions between the computer and the centralised processing unit 8. The installation of such software more particularly requires the prior input of the identifier, or serial number, of the processing centre, the reception of an RF flux, the making of patients' data anonymous, as well as the reception and the viewing of the reception signal.

In order to provide a video flux authorising a real time processing, one image out of two is acquired and transmitted by the probe, which makes it possible to reduce by half the transmission rate on the telecommunications rate. The missing images are then reconstructed by interpolation on the last two acquired images. The processing server then has all the images to reconstruct the echography image with a real time flux while providing the transmission in real time of data between the probes and the server.

High capacity processors receive as inputs the recomposed RF signal placed in data packets, with a dedicated frequency. Then, they send back as an output a video sampled signal so as to have only one signal out of two. This video signal can then be transmitted to the processing server 8.

According to a particular embodiment, a viewing interface and a remote control interface make it possible to adjust remotely the echography probe. Control means may for example be composed of a keyboard, a voice control or a touch screen.

This system makes it possible to locally have only the echography probe 2, 2′ and a computer including the conversion, control and display means. The rest of the operations, i.e. the construction of the echography image and the calculation of information, if any, for diagnosis purposes, will then be carried out using the centralised processing unit which is connected to various local echography devices.

The method makes it possible to provide for the centralised construction of echography images according to the invention as described hereinunder.

First, one radiofrequency signal at least is acquired by the echography probe 2, 2′ of each echography device 1, 1′.

This signal is then transmitted (I, II; I′, II″) to the conversion means 6,6′ to be converted into a format which is compatible, as regards the rate, with the telecommunications network 7, for example according to the standard Internet HTTP protocol, in the case of a network of the Internet type. This conversion consists in providing the digitised RF signals with compression and encoding steps.

Further on, the converted signal is transmitted (III, IV; III′, IV′) to a centralised radiofrequency signals processing unit 8 via the network 7. The transmitted signal is then processed by the processing unit with a view to constructing the echography image corresponding to the raw RF signal. This processing step can also be completed with an additional step of processing the signals and/or images with a view to supplying medical diagnosis information.

Finally, the constructed echography images, as well as diagnosis information, are transmitted (V, VI, V′, VI′) to the echography devices 1, 1′ via the network 7. The images can then be viewed on a display 4, 4′. Such images are transmitted so as to obtain a video flux, the rate of which enables a real time observation. In order to reach this real time observation, only one signal out of two can be transmitted to the mutualised processing unit with the latter performing an interpolation of the images supplied to recalculate estimations of the missing images. This makes it possible to reduce the data transmission rate while requiring no additional computer at the local echography device.

While referring to FIG 1a, the diagram illustrates the functional chain between the final user local centre L1 and a remote data processing centre D1. The analog radiofrequency signal Sₐ emanating from the detection probe of the local centre L1 is digitised and converted during the step of transforming the signal T1 into a signal capable of being transmitted to a remote data processing centre D1, so that the centralised processing unit (reference number 8 in FIG. 1), in the form of a converted signal S_{c} of imaging data. This signal S_{c} then has a format enabling the processing of data by the remote centre D1 to supply an echography signal Sₑ which is transmitted through the network 7 and processed during the transformation step D1 to form a video signal S^{c} compatible with the viewing means 4 of the local centre L1. The processing volume between the transformation step T1 and the remote centre D1 depends on the dedicated means at each one of the two processing poles and can thus vary and be adapted to circumstances, more particularly the processing capacity of local means.

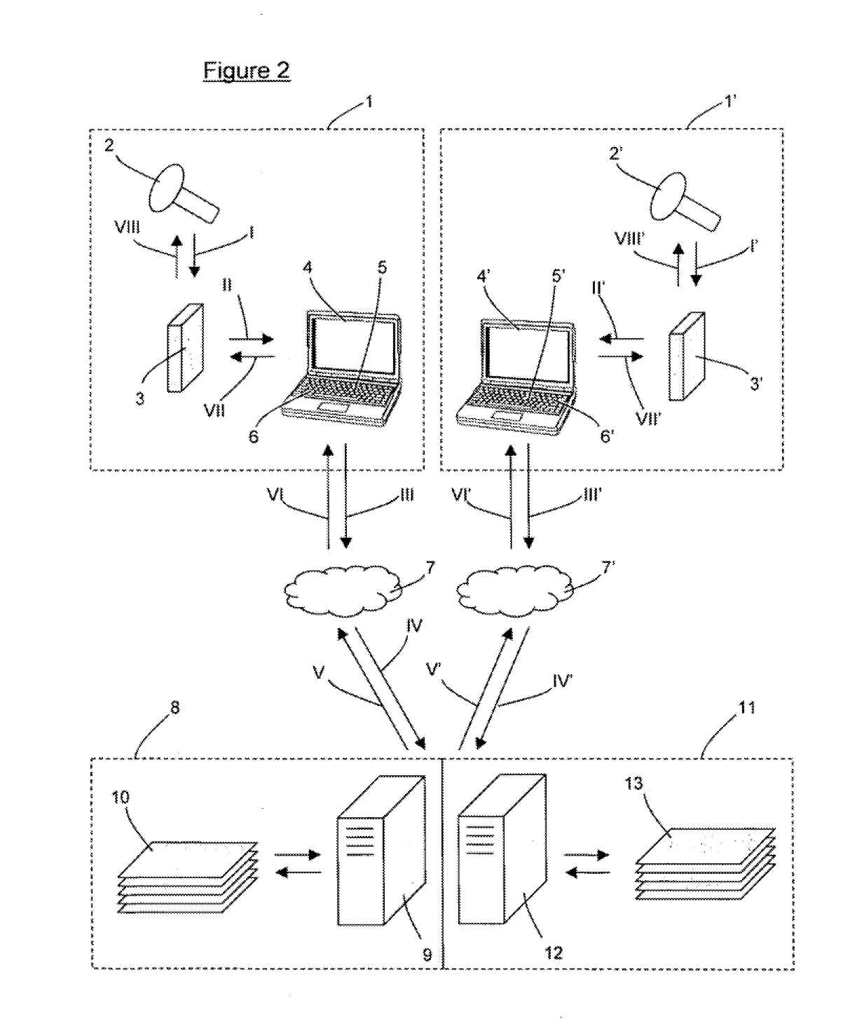

FIG. 2 shows a diagram of a centralised construction system of echography images according to a second embodiment of the invention. In this embodiment, the system also includes a security centralised processing unit 11, composed of a server 12 and a central unit 13. This unit 11 is moved to a secured location, out of reach of fire, water, theft and hacking. The central unit 13 is composed of a high capacity computer making it possible to construct the echography images. The server 12 makes it possible to redistribute the specific signals after the processing. Such a unit 11 makes it possible to have secure calculations, which are very useful in case of malfunction of the first processing unit 8.

In another embodiment, the centralised processing unit 8 may be provided with several servers. Load distribution software makes it possible to distribute the task between the servers.

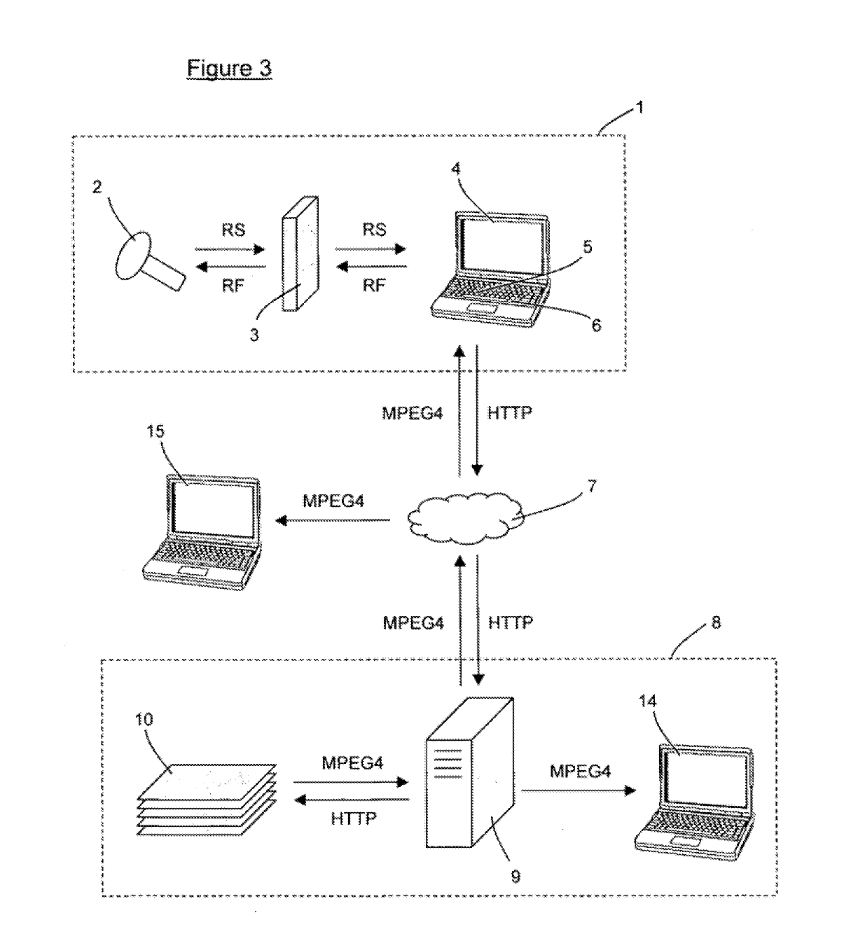

FIG. 3 shows a diagram of an exemplary embodiment of a system for constructing centralised echography images.

In this example, the probe 2 transmits to the (conversion, control and viewing) computer a standard radio signal (RS). This signal is converted at the computer into a signal in an

HTTP protocol enabling the transfer thereof on the Internet network 7. This signal is received by the server 9 of the centralised processing unit 8. Such unit 8 is moved with respect to a probe 2 and the computer. The server transmits the signal to the UTSE card 10 which will construct the echography images and create a signal in the MPEG format.

This signal is then sent to the server 8 which, on the one hand, sends it to a viewing monitor 10 to directly view at the unit 8 the created MPEG signal and, on the other hand, to transfer it on the Internet network 7. The MPEG signal is then transmitted to the computer to provide a local viewing of the signal on the computer display. Along this method, control information can be transmitted by the computer to the probe 2 in the form of RF signals.

MPEG signals transferred on the Internet network can also be transmitted to a remote viewing monitor 15 with respect to the probe, a computer 2 and a processing unit 8. Then, it is possible to view the echography images at any other location than that of the probe 1 and the computer 2, or than that of the centralised processing unit 5.

The MPEG signal transferred on the Internet network 7 can also be transmitted to a viewing monitor 14 located within the processing unit 8 to enable a centralised display of echography images emanating from several locations.

The previously described embodiments of the present invention are given as examples and are not limitative. Of course, the persons skilled in the art can provide various modifications in the invention and adapt it to various applications.

More particularly, this system can apply to any type of medical signal and all the applications using a sensor connected to information processing systems, such as for example electrocardiography, electroencephalography, Doppler echography, blood pressure as well as dimension and rate Holter analysis.

This system can more particularly be used, and in a non limitative way, for medical emergencies, clinical studies, developing countries (obstetrics and paediatrics), remote diagnosis, remote monitoring, medical practice, training, quality, secure databases and quantisation (with dedicated software). The quality of exams and the estimation thereof is simplified by the use of this system in the case of clinical studies, probes are distributed to the centres and make it possible to harmonise and centralise the collection of data.

It is also possible to autonomously adapt the present invention to a hospital. Such an environment can for example have several tens of echography probes and a network for transporting RF signals is then provided by an Internet network from Ethernet connections between the echography devices and the centralised processing unit. In this application, the problem of rate is not raised and it is then possible to omit the step of compressing the signals.

In the case of developing countries, the distribution of probes associated to the training and online assistance makes it possible to reduce the cost and increase efficiency. In the case of emergency medicine, the probe is positioned in a particular structure, i.e. an ambulance, an airport, industrial medicine or fire department. The associated remote diagnosis is then made possible.

Remote monitoring makes it possible to permanently track, if necessary, blood pressure and heart rate provided by a permanent sensor, for example, in the form of an arm cuff. Viewing means then can be composed of the screen of a mobile phone displaying alerts by SMS. It is then possible to follow persons driving cars or the equivalent, and to see the chronological order of an accident and the occurrence of a heart attack, if any. This remote monitoring can then be used as a remote recorder.

1-14. (canceled)

15. A method for centralising the construction of images comprising acquiring at least one radiofrequency signal with a sensor of at least one local imaging device, transmitting the at least one radiofrequency signal emanating from the sensor to a centralised processing unit to construct an image; transmitting the constructed image to a display of an acquisition device, wherein the transmission between the sensor and said processing unit and the transmission between said processing unit and the display are performed via a telecommunications network, wherein prior to said step of transmitting to said processing unit, the at least one radiofrequency signal emanating from said sensor is converted into a format compatible with the telecommunications network during a step of transformation of the signal, and wherein the local imaging device controls general gains and field depth through control of the sensor and the video imaging.

16. A method according to claim 15, further including additional processing of at least one of the at least one radiofrequency signal and the constructed image to facilitate interpretation of the signal by provision of information.

17. A method according to claim 15, further comprising supplying a video signal by transition to the step of transformation upon the transmission of the constructed image to the local display.

18. A method according to claim 15, wherein during the step of transmission between the sensor and said processing unit one radiofrequency signal out of two is transmitted to said processing unit and during the step of processing said radiofrequency signal, missing signals are reconstructed by interpolation of at least two successively transmitted signals.

19. A system for centralising the construction of images including at least one imaging device able to perform acquisition of a radiofrequency signal and display of an image; each said imaging device including a sensor, a display and sensor control means; a centralised processing unit able to construct an image from the radiofrequency signal emanating from said sensor: said processing unit including means for converting said radiofrequency signal into an image; each said imaging device and said processing unit include an interface with a telecommunications network and said sensor of each imaging device is provided with means for converting said radiofrequency signal into a format compatible with a transfer on said telecommunications network.

20. A system according to claim 19, wherein the converting means are composed of software capable to send a digital signal to the centralised processing unit via a network and to carry out restitution of a decompressed video signal emanating from the centralised processing unit via the same network.

21. A system according to claim 19, wherein the telecommunications network is a network of an Internet type.

22. A system according to claim 19, wherein the telecommunications network is a network of an Intranet type.

23. A system according to claim 19, wherein the telecommunications network is a microwave network.

24. A system according to claim 23, wherein the telecommunications network is selected between a Bluetooth, wi-fi and wire network.

25. A system according to claim 19, wherein the telecommunications network is a combination of at least two types of said networks.

26. A system according to claim 19, wherein said sensor is selected from the group consisting of an echography probe, a Doppler probe, a blood pressure probe, an electrocardiography probe and an encephalography probe.

27. A system according to claim 19, further including a security processing unit moved to a secure location different from a location of the centralised processing unit, said security processing unit including means for converting the radiofrequency signal into an image and an interface with said telecommunications network.

28. A system according to claim 19, wherein the centralised processing system also includes means for processing echography images supplying additional information for a medical diagnosis.
